(19) United States
(12) Patent Application Publication
(10) Pub. No.: US 2012/0273067 A1
(43) Pub. Date: Nov. 1, 2012

(54) VALVE ARRANGEMENT

(75) Inventor: Christian Spielvogel, Eutingen Im Gaeu (DE)

(73) Assignee: Robert Bosch GmbH, Stuttgart (DE)

(21) Appl. No.: 13/508,138

(22) PCT Filed: Sep. 15, 2010
(86) PCT No.: PCT/EP2010/005658

§ 371 Date: Jul. 15, 2012

(30) Foreign Application Priority Data
Nov. 5, 2009 (DE) 10 2009 052 076.7

(51) Int. Cl. F16K 31/12

(52) U.S. Cl. 137/505

(57) ABSTRACT

A hydraulic valve arrangement is disclosed. In particular, a regulating-valve arrangement of a variable displacement pump is disclosed, wherein a valve piston of a valve is pre-stressed into a basic position via a spring arrangement. The spring arrangement is supported on an expander.

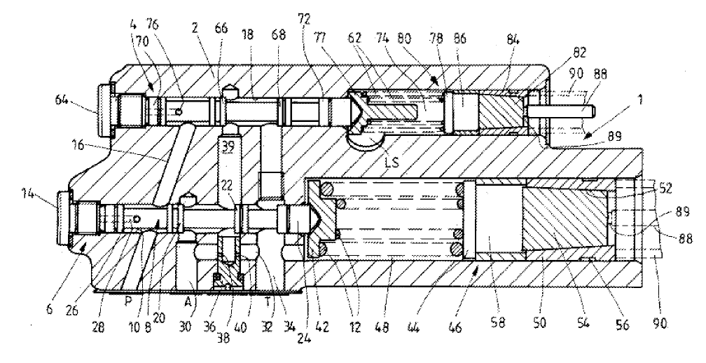

The present invention relates to a valve arrangement, in particular to a regulating valve of a variable displacement pump, according to the preamble of patent claim 1.

DE 101 36 416 A1 discloses a generic regulating valve subassembly. This has a valve housing, into which a pressure regulating valve and a delivery flow regulating valve are integrated. A regulating piston of the regulating valves is prestressed in each case by means of a regulating spring in one direction. In the known solution, a spring housing is attached to the valve housing on the end face and has arranged in it the respective regulating spring which acts on the regulating piston via a spring plate. This regulating spring is itself supported on a supporting disk which can be adjusted in the axial direction by means of a setscrew, so that the regulating spring prestress can be adjusted via the setscrew.

Regulating valves of this type for variable displacement pumps are mostly set at values desired by the customer. This setting is preferably carried out once only at the pump manufacturer's before the variable displacement pump is delivered. For this purpose, the variable displacement pumps are set on test benches by a tester during the production of the pumps and are secured against a subsequent inadvertent change in the setting. In generic regulating valves, for example, this securing takes place via a lock nut, via which the setscrew is braced together with the spring housing. In order to seal off the spring space, the known solution also requires O-rings which seal off, on the one hand, the overlap region between the spring housing and valve housing and, on the other hand, the region between the setscrew and spring housing, so that the spring space receiving the regulating spring is reliably closed off outwardly.

The disadvantage of this solution is that a multiplicity of structural elements for adjusting and supporting the regulating spring and a multiplicity of seals for sealing off the spring space have to be provided.

By contrast, the object on which the invention is based is to provide a simply constructed valve arrangement.

This object is achieved by means of a valve arrangement having the features of patent claim 1.

Advantageous refinements of the invention are the subject matter of the subclaims.

According to the invention, the hydraulic valve arrangement is designed with a valve housing in which a valve bore receiving a valve piston is formed. This valve piston is prestressed via a spring which is supported on a spring seat axially adjustable at least once. According to the invention, instead of the initially described screw adjustment which is of highly complicated form, this spring seat is designed as a radially expandable spreading sleeve which is inserted nonpositively into the valve bore and closes the latter. Radially expandable spreading sleeves of this type are also known by the term “expanders” and are also used in hydraulics. Thus, DE 199 33 371 A1 describes bracing a spreading sleeve by means of a throttle body which is formed with a contraction, along which the throttle body is torn off during bracing and then releases the throttle cross section.

U.S. Pat. No. 4,091,841 describes closing a pressure medium flow path by means of an expander.

However, there is no example in the prior art of the use of these expanders for the support of springs of a hydraulic valve arrangement.

By using spreading sleeves of this type, the complex screw thread adjustment according to the prior art can be dispensed with; furthermore, the number of sealing surfaces is appreciably reduced, as compared with this prior art, since this spreading sleeve can be inserted directly into a valve bore or an adjoining spring space, without an additional spring housing being required for receiving the above-described actuating device.

Accordingly, the number of structural elements and sealing surfaces can be considerably reduced, as compared with the solution initially described, so that both assembly and manufacture are simplified. For adjustment, the spreading sleeve which bears indirectly or directly against the spring is pushed into the valve bore or spring space until the desired set value is reached and is subsequently expanded radially, so that said spreading sleeve is braced sealingly together with the valve bore or spring space. During this radial expansion, the axial position of the spreading sleeve does not change, and therefore the desired set value is reliably maintained.

In a preferred exemplary embodiment of the invention, the spreading sleeve is designed with a tapered bolt which, for example, can be actuated via a tension rod fastened to it in order to expand the spreading sleeve radially. This tension rod is preferably provided with a predetermined breaking point, so that it can be released from the tapered bolt after the expansion of the spreading sleeve.

According to the invention, it is preferable if the spring-side end face of the spreading sleeve projects in the axial direction beyond the tapered bolt toward the spring at least by the amount of the assembly travel for expansion, so that the tapered bolt cannot be connected operatively to the spring either in the non-expanded basic position of the spreading sleeve or in the spreading position.

This can be organized in an especially simple way in that the spreading sleeve has adjoining it on the spring side a spacer piece which forms this spring-side end face and the axial length of which is defined such that the tapered bolt, in the state inserted loosely into the spreading sleeve, does not project beyond the spacer piece in the axial direction.

This spacer piece may be formed in one piece with the spreading sleeve or as a separate component.

In an exemplary embodiment of the invention, a supporting disk, which serves as a bearing piece for the spring, is arranged between the spacer piece and the spring.

This supporting disk may, in turn, be formed as a separate component or else in one piece with the spacer piece. In an exemplary embodiment, an inner bore of the spreading sleeve is formed so as to be contradirectionally conical to the tapered bolt. The inside diameter of the spacer piece is designed to be correspondingly larger than the largest diameter of the tapered bolt or of the spreading sleeve.

For a further improvement in fixing the position of the spreading sleeve, circumferential grooves may be formed on its outer circumference, which cause “catching” with the circumferential wall of the valve bore and thus improves the fit.

In a preferred exemplary embodiment of the invention, the regulating springs of a delivery flow regulating valve and of a pressure regulating valve of a pump controller are supported via a spreading sleeve in the way described above.

A preferred exemplary embodiment is explained in more detail below by means of a single FIGURE which shows a longitudinal section through a regulating valve arrangement 1 of a pump controller. The basic construction of this regulating valve arrangement 1 is described in detail in the initially described prior art according to DE 101 36 416 A1. The diagrammatic construction of the pump controller is explained, furthermore, in data sheet RD 92 711/10.07 issued by Bosch Rexroth AG, and therefore only the structural elements essential for understanding the invention are described below and, for the sake of simplicity, reference is otherwise made to the abovementioned prior art.

The regulating valve arrangement 1 has a valve housing in which a delivery flow regulating valve 4 and a pressure regulating valve 6 are received. The pressure regulating valve 6 causes the pressure in a hydraulic system to be kept constant within the regulating range of the pump. By means of the delivery flow regulating valve 4, the delivery flow of the pump can be set by the consumer via a differential pressure, so that the pump delivers only the pressure medium quantity actually required by the consumer.

A pressure connection P carrying the pump pressure, a working connection A, a tank connection T and an LS connection X, merely indicated in the figure, are provided on the valve housing. Said working connection A is a pressure medium connection with a pressure space of an actuating cylinder, via which, as explained in data sheet RD 92 711, a pivot angle of a variable displacement axial piston pump can be adjusted. A swashplate of this displacement axial piston pump is pivoted out via a spring mechanism and can be pivoted back by the pressure in the pressure space of the actuating cylinder. The highest load pressure of all the consumers of the system supplied with pressure medium via the pump is present at the LS connection X and is picked off by the consumers, for example, via a shuttle valve cascade.

The pressure regulating valve 6 has a pressure regulating piston 8 which is guided in a valve bore 10 and which is prestressed via a pressure regulating spring arrangement 12 having two springs arranged coaxially to one another into the basic position illustrated, in which said pressure regulating piston 8 bears against a screw plug 14 inserted into the valve bore 10. A pressure duct 16 leading to the pressure connection P and designed as an oblique bore issues into the valve bore 10 and extends beyond the valve bore 10 as far as a valve bore 18 of the delivery flow regulating valve 4. The pressure regulating piston 8 is designed with a control collar 20, with a guide collar 22 arranged adjacently to the latter and with two end collars 24 and 26. The end collar 26 on the left in the figure bears, in the basic position, against the screw plug 14 and delimits with the latter a control space, which cannot be seen in the figure, and which is acted upon, via a control bore 28 designed as an angle bore, by the pressure in the annular space between the end collar 26 and the control collar 20. This control pressure corresponds to the pump pressure.

A working duct 30, likewise designed as a blind hole bore, issues into the working connection A connected hydraulically to the actuating cylinder and intersects the valve bore 10 and into which, in the basic position illustrated, the control collar 20 penetrates with its right end portion, so that the pressure medium connection between the pressure connection P and the working connection A is shut off.

Below the valve bore 10 in the figure, a longitudinal duct 32 runs parallel to the latter and issues on the right into a tank duct 34 leading to the tank connection T. Inserted into this longitudinal duct 32 in the transverse direction is a nozzle body 36 with two radial nozzles 38, 40, via which the working duct 30 is connected to the tank duct 34.

Between these two nozzles 38, 40, an intermediate duct 39 issues, which connects the two valve bores 10, 18 to one another and into which, in the basic position illustrated, a left end portion of the guide collar 22 penetrates, so that, in this basic position, the pressure medium connection between the working duct 30 and the connecting duct 39 is opened by means of the control groove between the two collars 20, 22.

The end collar 24 on the right in the figure bears against a spring plate 42, on which the pressure regulating spring arrangement 12 acts. The latter is supported on a supporting disk 44 which itself bears via a spacer sleeve 58 against an expander 46 which is inserted nonpositively into a spring space 48 designed coaxially to the valve bore 10. The axial position of the expander 46 and of the supporting disk 44 within the spring space 48 determines the prestress of the pressure regulating spring arrangement 12 and therefore the regulating pressure of the pressure regulating valve 6. The expander 46 has a radially expandable spreading sleeve 50 with a tapered bore 52 which tapers conically to the right and which is braced together with a tapered bolt 54. This tapered bolt 54 can be displaced to the right in the axial direction via a suitable device, for example via a tear-off pin 88 or another device, in order to expand the spreading sleeve 50 in the radial direction and to brace it nonpositively and sealingly with the outer circumference of the spring space 48. The geometry of the spreading sleeve 50 is selected such that this bracing is accompanied by material deformation which assists the nonpositive connection. In the exemplary embodiment illustrated, one or more circumferential grooves 56 are provided on the outer circumference of the spreading sleeve 50. As stated initially, these circumferential grooves 56 serve for improving the fit of the spreading sleeve 50 against the circumferential wall surrounding it. The number and shape of the circumferential grooves 56 are dependent upon the material pairing (spreading sleeve 50, valve housing 2). A circumferential groove of this type may basically also be dispensed with.

Since, as illustrated in the figure, the tapered bolt 54 projects to the left beyond the spreading sleeve 50 in the non-braced state and also in the braced state (see the figure), a spacer sleeve 58 is provided as a function of this assembly travel (axial distance between the non-braced and braced position of the tapered bolt 54), the axial length of said spacer sleeve being greater than the abovementioned travel, so that the tapered bolt 54 can be moved without colliding with the supporting disk 44. For assembly, the unit composed of the supporting disk 44, spacer sleeve 58, spreading sleeve 50 and tapered bolt 54 is inserted into the spring space 48 and is adjusted until the desired set values are reached. This setting preferably takes place hydraulically, that is to say, when the valve arrangement is in operation, the expander 46 is pushed into the spring space 48 until the pressure cut-off has reached the desired pressure value, for example 250 bar. The axial position assumed in this case by the expander 46 is then secured via a stay 90, indicated by dashes, which bears on the end face against the spreading sleeve 50.

Subsequently, for the radial expansion of the spreading sleeve 50, the tapered bolt 54 is moved by means of the tear-off pin 88 out of its non-braced position, not illustrated, to the right until the spreading sleeve 50 bears nonpositively against the circumferential wall of the spring space 48, the supporting disk 44 always being held at a distance from the tapered bolt 54 via the spacer sleeve 58. After the bracing of this expander 46, the spring space 48 is shut off, pressure-tight, and the prestress of the pressure regulating spring arrangement 12 is fixed and can no longer inadvertently be changed. The tear-off pin 88 tied to the tapered bolt 54 via a predetermined breaking point 89 is torn off when a specific tensile force is exceeded, so that it is then separated from the tapered bolt 54.

The delivery flow regulating valve 4 illustrated at the top in the figure has a regulating piston 60 which is displaceable in the valve bore 18 and, in the basic position according to the figure, is prestressed via a regulating spring arrangement 62 against a further screw plug 64. The regulating piston 60 has a control collar 66, a guide collar 68 and two end collars 70, 72. The last-mentioned end collar 72 penetrates into a spring space 74 for the regulating spring arrangement 62, and the other end collar 70 bears, in the basic position, against the screw plug 64 and delimits with the latter a control space which is acted upon via a further control bore 76 designed as an angle bore by the pressure in an annular space between the control collar 66 and the end collar 70. The pressure duct 16 issues into this annular space, so that the pump pressure is present in the left control space of the delivery flow regulating valve 4.

The control collar 66 is designed such that, in the basic position, it shuts off the pressure medium connection of said control space and therefore of the pressure duct 16 to the intermediate duct 39. In the basic position illustrated, the pressure medium connection between the intermediate duct 39 and the tank duct 34 is opened via the control groove between the control collar 66 and the guide collar 68, so that, correspondingly, the working connection A is connected to the tank connection T via the working duct 30, the intermediate duct 39 and the tank duct 34 and therefore the pressure space of the actuating cylinder is acted upon by tank pressure for the purpose of adjusting the pivot angle (pump pivoted out).

The regulating spring arrangement 62 acts via a spring plate 77 on the end collar 72 of the regulating piston 60 and is supported on a supporting disk 78, the axial position of which is likewise fixed via an expander 80. The construction of the expander 80 corresponds to that of the expander 46 of the pressure regulating valve 6. Accordingly, a spreading sleeve 84 is braced together with the circumferential wall of the spring space 62 via a tapered bolt 82, a spacer sleeve 86 being provided once again in order to make it possible to have the required assembly stroke of the tapered bolt without the latter colliding with the supporting disk 78. Near the expander 80, the abovementioned tear-off pin 88 can also be seen, which projects in the axial direction out of the valve housing 2 and can be removed completely.

The highest load pressure of the activated consumers acts in the region of the spring space 74 between the expander 80 and the end collar 72 and is picked off via the LS connection X. Accordingly, the regulating piston 60 of the delivery flow regulating valve 4 is acted upon, on the one hand, by the pump pressure and, on the other hand, by the load pressure and by the force of the regulating spring arrangement 62, so that, in the regulating position, the pump pressure is set at a value which lies above the highest load pressure by the amount of the pressure equivalent of the regulating spring arrangement 62. In this regulating position, the control collar 66 overlaps with the intermediate duct 39, so that a variable displacement pump can be pivoted out (connection to tank pressure) or pivoted back (connection to pump pressure), depending on the variation in pressure difference at a metering diaphragm, not illustrated.

Further explanations of the functioning of the pump controller are unnecessary if the prior art initially described is referred to.

The particular advantage of the design according to the invention with the regulating spring supported against an expander is that the valve housing can be constructed extremely simply, since measures for attaching an adjusting and sealing system do not have to be taken. The number and complexity of the structure elements when an expander is used can be reduced most appreciably, as compared with conventional solutions, the leaktightness problems being as far as possible eliminated, since sealing bearing contact of the spreading sleeve against the circumferential wall of the spring space and sealing bearing contact of the tapered bolt against the inner circumference of the spreading sleeve are readily possible by a suitable choice of material and by machining, the surface quality having to satisfy comparatively low requirements.

It is pointed out that the term “valve arrangement” or “spring arrangement” may also relate to an individual valve or an individual spring.

What is disclosed is a hydraulic valve arrangement, in particular a regulating valve arrangement of a variable displacement pump, a valve piston of a valve being prestressed into a basic position via a spring arrangement. This spring arrangement is supported on an expander.

1. A hydraulic valve arrangement comprising:
a valve housing defining a valve bore in which a valve piston is inserted and is axially displaceable, the valve piston is prestressed by a spring in one direction, the spring being supported on a spring seat that is axially adjustable at least once,
wherein the spring seat has an expandable spreading sleeve which is inserted nonpositively into the valve bore or into a spring space adjoining the latter.

2. The valve arrangement as claimed in claim 1, wherein the spreading sleeve includes a tapered bolt that is configured to be adjusted via a tension rod for expanding the spreading sleeve radially, the tension rod being configured with a predetermined breaking point.

3. The valve arrangement as claimed in claim 2, wherein the spreading sleeve a spring-side end face that projects axially beyond the tapered bolt at least by the amount of actuating travel for expansion.

4. The valve arrangement as claimed in claim 3, wherein the spreading sleeve includes a spacer piece that adjoins the spreading sleeve in the axial direction and forms the spring-side end face, the spacer piece has an axial length that is configured such that the tapered bolt, particularly in the state inserted loosely into the spreading sleeve, does not project axially toward the spring beyond the spacer piece.

5. The valve arrangement as claimed in claim 4, wherein the spacer piece is formed in one piece with the spreading sleeve or is configured as a separate component.

6. The valve arrangement as claimed in claim 5, wherein the spacer piece has an inside diameter that is larger than a diameter of the tapered bolt and larger than an inside diameter of the spreading sleeve.

7. The valve arrangement as claimed in claim 4, further comprising a supporting disk configured to act as a spring seat for the spring, the supporting disk being arranged between the spacer piece and the spring.

8. The valve arrangement as claimed in claim 1, wherein the spreading sleeve has an outer circumference that includes one or more circumferential grooves.

9. The valve arrangement as claimed in claim 1, wherein the valve is a delivery flow regulating valve or a pressure regulating valve of a pump controller.
